(19) United States
(12) Patent Application Publication
(10) Pub. No.: US 2025/0044532 A1
(43) Pub. Date: Feb. 6, 2025

(54) OPTICAL COUPLING STRUCTURE FOR SEMICONDUCTOR DEVICE

(71) Applicant: Taiwan Semiconductor Manufacturing Co., Ltd., Hsinchu (TW)

(72) Inventors: Tung-Liang Shao, Hsinchu (TW); Yu-Sheng Huang, Hemei Township (TW); Chen-Hua Yu, Hsinchu (TW)

(21) Appl. No.: 18/352,655

(22) Filed: Aug. 1, 2023

(51) Int. Cl. G02B 6/42

(52) U.S. Cl. CPC G02B 6/423; G02B 6/4204; G02B 6/4274

(57) ABSTRACT

A package includes an optical engine attached to a package substrate, wherein the optical engine includes a first waveguide; and a waveguide structure attached to the package substrate adjacent the optical engine, wherein the waveguide structure includes a second waveguide within a transparent block, wherein a bottom surface of the transparent block is nonplanar, wherein the second waveguide is a fixed distance from the bottom surface along its length, wherein the second waveguide is optically coupled to the first waveguide.

### BACKGROUND

Electrical signaling and processing are one technique for signal transmission and processing. Optical signaling and processing have been used in increasingly more applications in recent years, particularly due to the use of optical fiber-related applications for signal transmission.

Optical signaling and processing are typically combined with electrical signaling and processing to provide full-fledged applications. For example, optical fibers may be used for long-range signal transmission, and electrical signals may be used for short-range signal transmission as well as processing and controlling. Accordingly, devices integrating optical components and electrical components are formed for the conversion between optical signals and electrical signals, as well as the processing of optical signals and electrical signals. Packages thus may include both optical (photonic) dies including optical devices and electronic dies including electronic devices.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1-9 illustrate the formation of an optical package, in accordance with some embodiments.

FIGS. 10 and 11 illustrate photonic packages, in accordance with some embodiments.

FIGS. 12 and 13 illustrate the formation of a waveguide structure, in accordance with some embodiments.

FIGS. 14, 15, and 16 illustrate views of a waveguide structure, in accordance with some embodiments.

FIG. 17 illustrate a coupling structure, in accordance with some embodiments.

FIGS. 18 and 19 illustrate the formation of photonic system, in accordance with some embodiments.

FIGS. 20 and 21 illustrate photonic systems, in accordance with some embodiments.

FIGS. 22 and 23 illustrate waveguide structures, in accordance with some embodiments.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

A photonic system including a waveguide structure for integrating optical fibers with an optical engine and the method of forming the same are provided. The waveguide structure includes waveguides formed by laser writing into a curved surface of the waveguide structure. Forming a waveguide structure having a curved surface allows the laser-written waveguides to conform to the contour of the curved surface, which allows waveguides to be formed at a consistent shallow depth below the curved surface. Forming waveguides at a shallow depth can improve the quality of the waveguides. The laser-written waveguides transmit optical signals and/or optical power between optical fibers and other optical features such as waveguides and/or edge couplers. Embodiments discussed herein are to provide examples to enable making or using the subject matter of this disclosure, and a person having ordinary skill in the art will readily understand modifications that can be made while remaining within contemplated scopes of different embodiments. Throughout the various views and illustrative embodiments, like reference numbers are used to designate like elements. Although method embodiments may be discussed as being performed in a particular order, other method embodiments may be performed in any logical order.

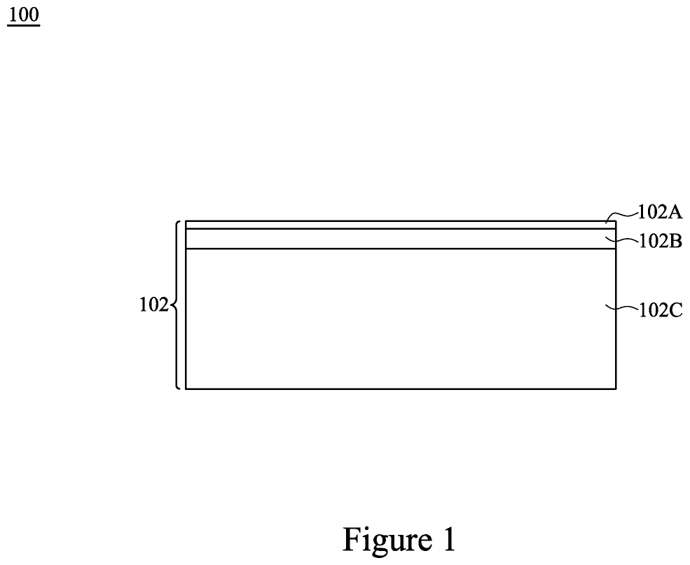

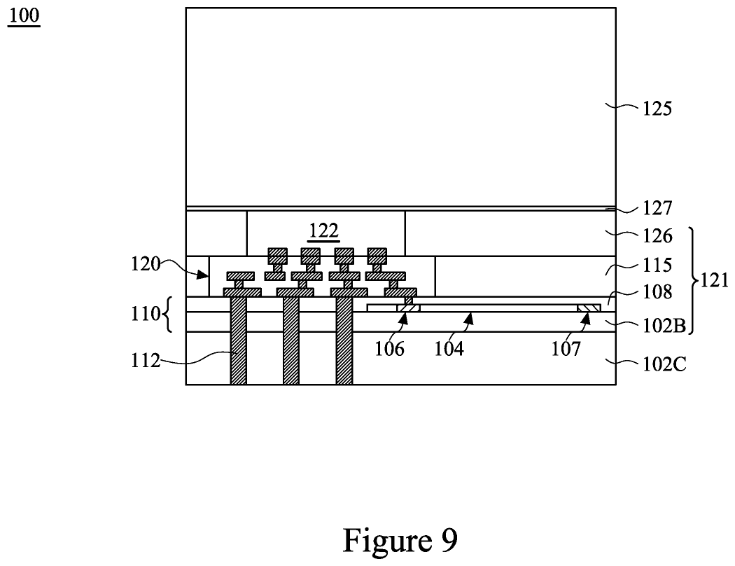

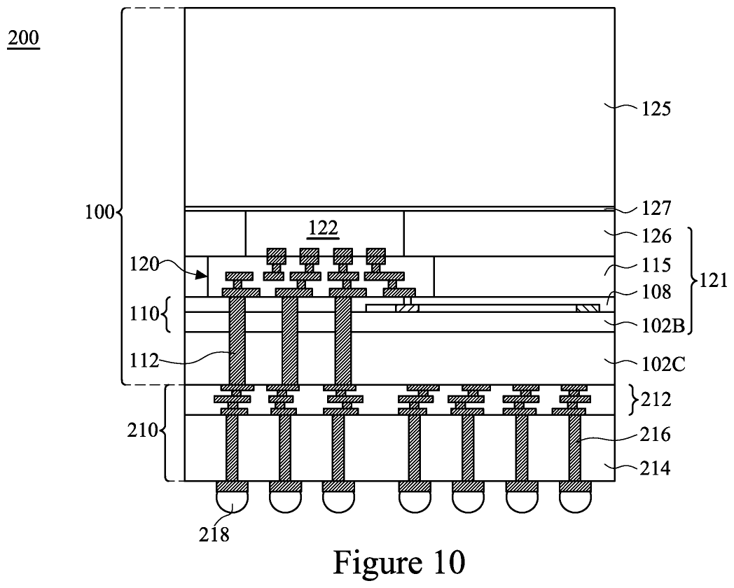

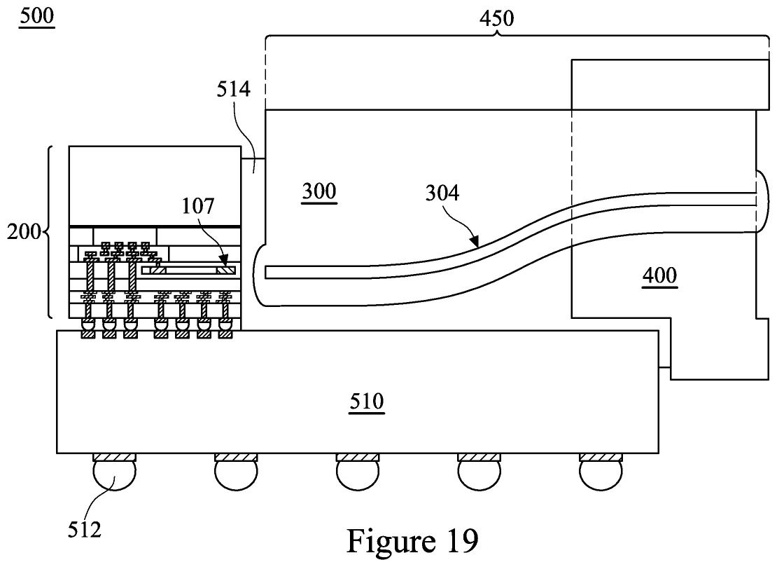

FIGS. 1 through 9 show cross-sectional views of intermediate steps of forming an optical engine 100 (see FIG. 9), in accordance with some embodiments. In some embodiments, the optical engine 100 may act as an input/output (I/O) interface between optical signals and electrical signals. One or more optical engines may be used in a photonic package, photonic structure, photonic system, or the like. For example, one or more optical engines 100 may be used in a photonic system such as the photonic structure 200 described below for FIG. 10, a photonic system such as the photonic system 500 described below for FIG. 19, other embodiments described herein, or the like. In some embodiments, multiple optical engines 100 are formed on the same substrate (e.g., substrate 102 of FIG. 1) and then subsequently singulated into individual optical engines 100.

Turning first to FIG. 1, a buried oxide (“BOX”) substrate 102 is provided, in accordance with some embodiments. The BOX substrate 102 includes an oxide layer 102B formed over a substrate 102C, and a silicon layer 102A formed over the oxide layer 102B. The substrate 102C may be, for example, a material such as a glass, ceramic, dielectric, a semiconductor, the like, or a combination thereof. In some embodiments, the substrate 102C may be a semiconductor substrate, such as a bulk semiconductor or the like, which may be doped (e.g., with a p-type or an n-type dopant) or undoped. The substrate 102C may be a wafer, such as a silicon wafer (e.g., a 12 inch silicon wafer). Other substrates, such as a multi-layered or gradient substrate may also be used. In some embodiments, the semiconductor material of the substrate 102C may include silicon; germanium; a compound semiconductor including silicon carbide, gallium arsenic, gallium phosphide, indium phosphide, indium arsenide, and/or indium antimonide; an alloy semiconductor including silicon germanium, GaAsP, AlInAs, AlGaAs, GaInAs, GaInP, and/or GaInAsP; or combinations thereof. The oxide layer 102B may be, for example, a silicon oxide or the like. In some embodiments, the oxide layer 102B may have a thickness between about 0.5 μm and about 4 μm. The silicon layer 102A may have a thickness between about 0.1 μm and about 1.5 μm, in some embodiments. Other thicknesses or materials are possible. The BOX substrate 102 may be referred to as having a front side or front surface (e.g., the side facing upwards in FIG. 1), and a back side or back surface (e.g., the side facing downwards in FIG. 1).

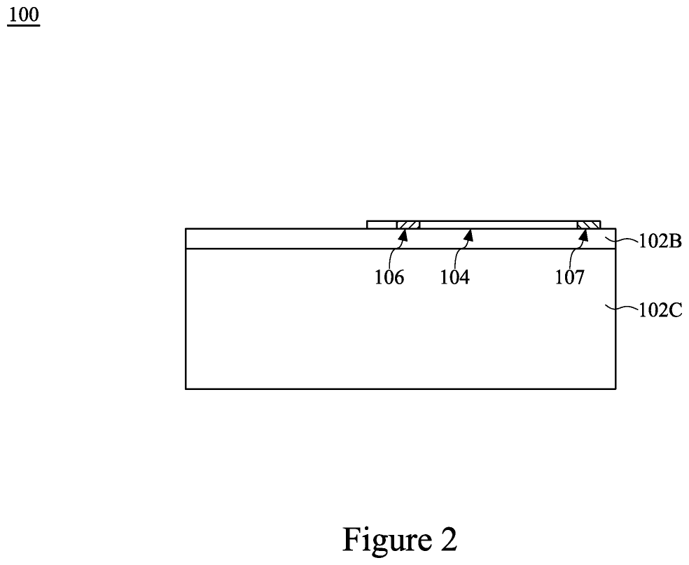

In FIG. 2, the silicon layer 102A is patterned to form silicon regions for waveguides 104, photonic components 106, and/or edge couplers 107, in accordance with some embodiments. The silicon layer 102A may be patterned using suitable photolithography and etching techniques. For example, a hardmask layer (e.g., a nitride layer or other dielectric material, not shown in FIG. 2) may be formed over the silicon layer 102A and patterned, in some embodiments. The pattern of the hardmask layer may then be transferred to the silicon layer 102A using one or more etching techniques, such as dry etching and/or wet etching techniques. For example, the silicon layer 102A may be etched to form recesses defining the waveguides 104, with sidewalls of the remaining unrecessed portions defining sidewalls of the waveguides 104. In some embodiments, more than one photolithography and etching sequence may be used in order to pattern the silicon layer 102A. One waveguide 104 or multiple waveguides 104 may be patterned from the silicon layer 102A. If multiple waveguides 104 are formed, the multiple waveguides 104 may be individual separate waveguides 104 or connected as a single continuous structure. In some embodiments, one or more of the waveguides 104 form a continuous loop. Other configurations or arrangements of waveguides 104, the photonic components 106, or the edge couplers 107 are possible. In some cases, the waveguides 104, the photonic components 106, and the edge couplers 107 may be collectively referred to as “the photonic layer.”

The photonic components 106 may be integrated with the waveguides 104, and may be formed with the silicon waveguides 104 in some embodiments. The photonic components 106 may be physically and/or optically coupled to the waveguides 104 to interact with optical signals within the waveguides 104. The photonic components 106 may include, for example, photodetectors, modulators, or the like. For example, a photodetector may be optically coupled to the waveguides 104 to detect optical signals within the waveguides 104 and generate electrical signals corresponding to the optical signals. A modulator may be optically coupled to the waveguides 104 to receive electrical signals and generate corresponding optical signals within the waveguides 104 by modulating optical power within the waveguides 104. In this manner, the photonic components 106 can facilitate the input/output (I/O) of optical signals to and from the waveguides 104. In other embodiments, the photonic components may include other active or passive components, such as laser diodes, LEDs, optical signal splitters, phase shifters, resonators, amplifiers, optical cavities, evanescent couplers, grating couplers, or other types of structures or devices. Optical power may be provided to the waveguides 104 by, for example, an optical fiber (not shown in FIGS. 1-9) coupled to an external light source (e.g., by an edge coupler 107 or a grating coupler), or optical power may be provided by a photonic component within the optical engine 100 such as a laser diode or the like (not shown in FIGS. 1-9). In some embodiments, optical power and/or optical signals may be transmitted to the waveguides 104 from an adjacent optical engine, photonic package, photonic structure, photonic system, photonic component, or the like.

In some embodiments, a photonic component 1o6 such as a photodetector may be formed by, for example, partially etching regions of the waveguides 104 and growing an epitaxial material on the remaining silicon of the etched regions. The waveguides 104 may be etched using acceptable photolithography and etching techniques. The epitaxial material may comprise, for example, a semiconductor material such as germanium (Ge) or the like, which may be doped or undoped. In some embodiments, an implantation process may be performed to introduce dopants (e.g., p-type dopants, n-type dopants, or a combination) within the silicon of the etched regions or within the epitaxial material. In some embodiments, a photonic component 106 such as a modulator may be formed by, for example, partially etching regions of the waveguides 104 and then implanting appropriate dopants (e.g., p-type dopants, n-type dopants, or a combination) within the remaining silicon of the etched regions. The waveguides 104 may be etched using acceptable photolithography and etching techniques. In some embodiments, the etched regions used for a photodetector and the etched regions used for a modulator may be formed using one or more of the same photolithography or etching steps. In some embodiments, the etched regions used for a photodetector and the etched regions used for a modulator may be implanted using one or more of the same implantation steps. Other photonic components 106 and other manufacturing steps are possible.

In some embodiments, one or more edge couplers 107 may be integrated with the waveguides 104, and may be formed with the waveguides 104. The edge couplers 107 may be continuous with the waveguides 104 and may be formed in the same processing steps as the waveguides 104 or other photonic components 106. An edge coupler 107 allows optical signals and/or optical power to be transferred between a waveguide 104 and an optical or photonic component that is near an adjacent sidewall of the optical engine 100. For example, an edge coupler 107 may be optically coupled to a component such as another waveguide (e.g., a waveguide 304 described below), another optical engine, another photonic package, another photonic system, an optical fiber, an external laser diode, or the like. An optical engine 100 may include a single edge coupler 107 or multiple edge couplers 107. The couplers 107 may be formed using acceptable photolithography and etching techniques, in some embodiments. The couplers 107 may be formed using the same photolithography or etching steps as the waveguides 104 and/or the photonic components 106, in some embodiments. In other embodiments, the couplers 107 are formed after the waveguides 104 and/or the photonic components 106 are formed.

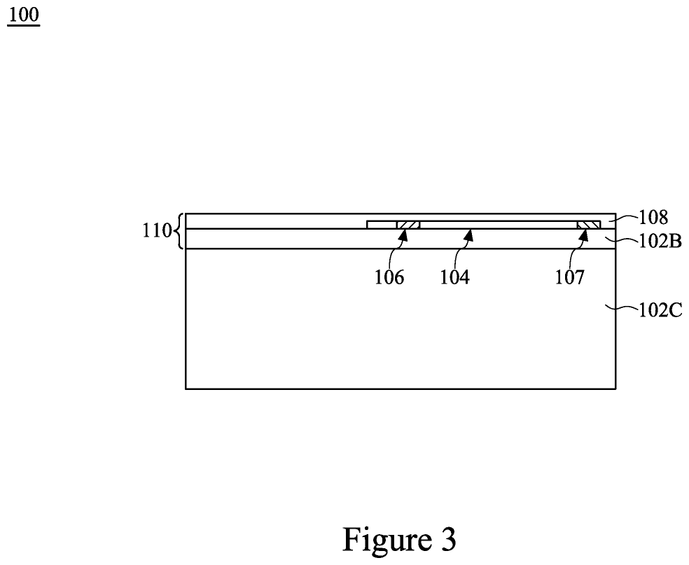

In FIG. 3, a dielectric layer 108 is formed on the front side of the BOX substrate 102 to form a photonic routing structure 110, in accordance with some embodiments. The dielectric layer 108 is formed over the waveguides 104, the photonic components 106, the edge couplers 107, and the oxide layer 102B. The dielectric layer 108 may be formed of one or more layers of silicon oxide, silicon nitride, a combination thereof, or the like, and may be formed by CVD, PVD, atomic layer deposition (ALD), a spin-on-dielectric process, the like, or a combination thereof. In some embodiments, the dielectric layer 108 may be formed by a high density plasma chemical vapor deposition (HDP-CVD), a flowable CVD (FCVD) (e.g., a CVD-based material deposition in a remote plasma system and post curing to make it convert to another material, such as an oxide), the like, or a combination thereof. Other dielectric materials formed by any acceptable process may be used. In some embodiments, the dielectric layer 108 is then planarized using a planarization process such as a CMP process, a grinding process, or the like. The dielectric layer 108 may be formed having a thickness over the oxide layer 102B between about 50 nm and about 500 nm, or may be formed having a thickness over the waveguides 104 between about 10 nm and about 200 nm, in some embodiments. Other thicknesses are possible.

Due to the difference in refractive indices of the materials of the waveguides 104 and dielectric layer 108, the waveguides 104 have high internal reflection such that light is substantially confined within the waveguides 104, depending on the wavelength of the light and the refractive indices of the respective materials. In an embodiment, the refractive index of the material of the waveguides 104 is higher than the refractive index of the material of the dielectric layer 108. For example, the waveguides 104 may comprise silicon, and the dielectric layer 108 may comprise silicon oxide and/or silicon nitride. In other embodiments, the waveguides 104 may be formed of silicon nitride or the like. Other materials are possible.

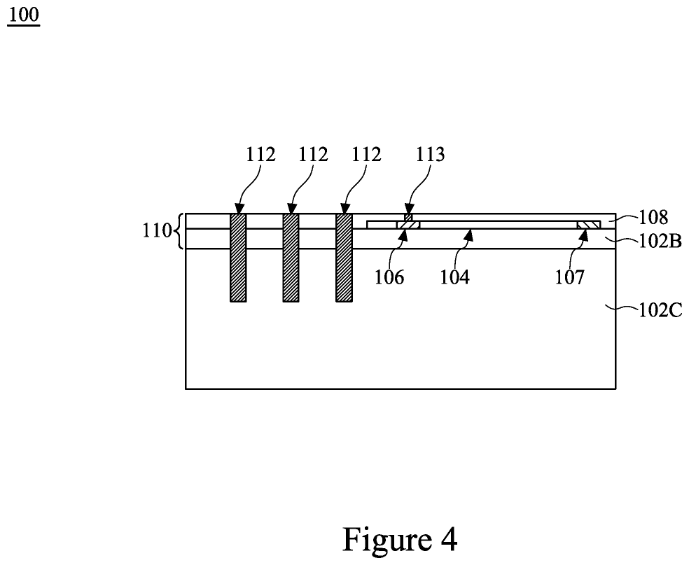

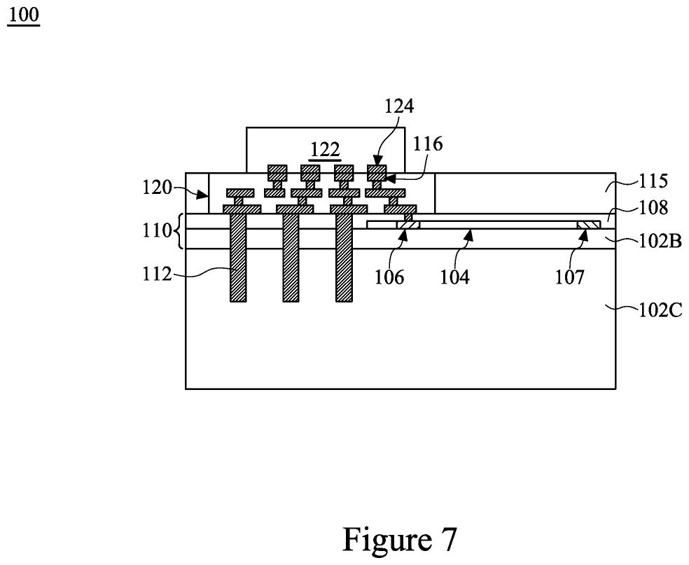

In FIG. 4, vias 112 and contacts 113 are formed, in accordance with some embodiments. The vias 112 extend into the substrate 102C and allow electrical connections to be formed at the back side of the optical engine 100. The contacts 113 allow electrical signals and/or electrical power to be transmitted to or from appropriate photonic components 106. In this manner, the photonic components 106 may convert electrical signals (e.g., from an electronic die 122, see FIG. 7) into optical signals that are transmitted by the waveguides 104, or the photonic components 106 may convert optical signals within the waveguides 104 into electrical signals (e.g., that may be received by an electronic die 122). The vias 112 and/or the contacts 113 may be formed, for example, by forming openings (not separately illustrated) in the dielectric layer 108. Openings where vias 112 are subsequently formed may extend through the dielectric layer 108, through the oxide layer 102B, and partially into the substrate 102C, in accordance with some embodiments. The openings may be formed by acceptable photolithography and etching techniques, such as by forming and patterning a photoresist and then performing an etching process using the patterned photoresist as an etching mask. The etching process may include, for example, a dry etching process and/or a wet etching process. The openings for the vias 112 and the openings for the contacts 113 may be formed separately or may be formed using one or more simultaneous steps.

Conductive material is then deposited in the openings, thereby forming vias 112 and contacts 113, in accordance with some embodiments. In some embodiments, a liner (not shown), such as a diffusion barrier layer, an adhesion layer, or the like, may first be deposited in the openings. The liner may comprise, for example, tantalum nitride, tantalum (Ta), titanium nitride, titanium (Ti), cobalt tungsten, or the like, and may be formed using a suitable deposition process such as CVD, PVD, ALD or the like. In some embodiments, the vias 112 and/or the contacts 113 may be formed by depositing a seed layer (not shown) in the openings. The seed layer may be deposited on the liner, if present. The seed layer may comprise copper, a copper alloy, or the like, in some embodiments. The conductive material may then be formed in the openings 111 using, for example, ECP or electro-less plating. The conductive material may include, for example, a metal or a metal alloy such as copper, silver, gold, tungsten, cobalt, ruthenium, aluminum, or alloys thereof. A planarization process (e.g., a CMP process or a grinding process) may be performed to remove excess conductive material along the top surface of the dielectric layer 108, such that top surfaces of the vias 112, contacts 113, and/or the dielectric layer 108 are level. This is an example, and the vias 112 and/or the contacts 113 may be formed using any suitable techniques, such as by a damascene process (e.g., single damascene or dual damascene), the like, or another process. The contacts 113 may be formed before or after formation of the vias 112, and the formation of the contacts 113 and the formation of the vias 112 may share some steps such as deposition of the conductive material and/or planarization. The vias 112 and the contacts 113 may be formed using other techniques or materials in other embodiments. The vias 112 and the contacts 113 may be formed using similar techniques or materials or different techniques or materials. More or fewer vias 112 or contacts 113 may be formed than shown in the figures, and in some other embodiments no vias 112 are formed.

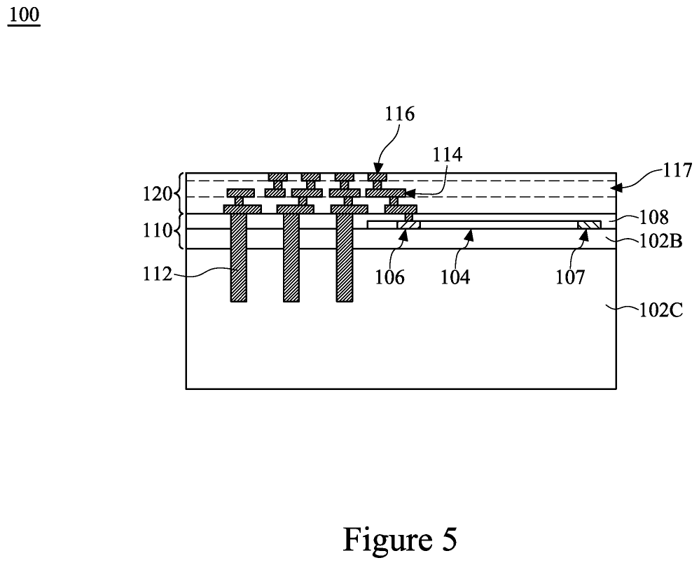

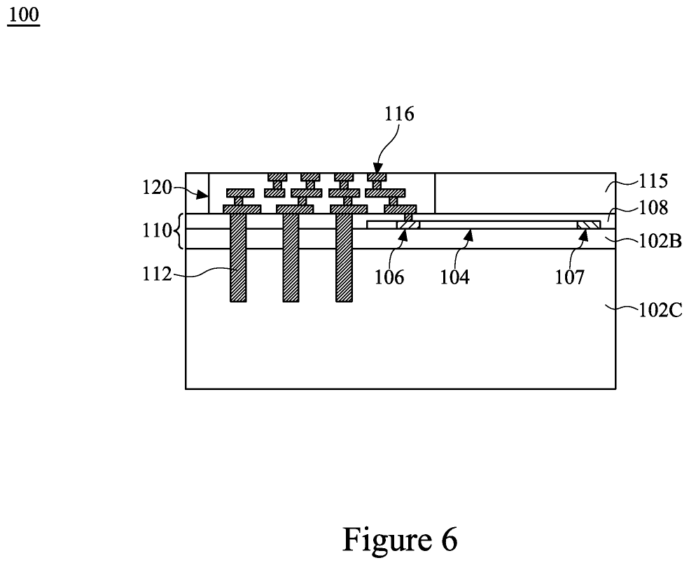

In FIG. 5, a redistribution structure 120 is formed over the dielectric layer 108, in accordance with some embodiments. The redistribution structure 120 includes one or more dielectric layers 117 and conductive features 114 formed in the dielectric layer(s) 117 that provide interconnections and electrical routing. For example, the redistribution structure 120 may connect the vias 112, the contacts 113, and/or overlying devices such as electronic dies 122 (see FIG. 7). In some other embodiments, the redistribution structure 120 may electrically connect to the photonic component 106 instead of a contact 113, or the contact 113 may be considered part of the redistribution structure 120. The dielectric layers 117 may be, for example, insulating or passivating layers, and may comprise one or more materials similar to those described above for the dielectric layer 108, such as a silicon oxide or a silicon nitride, or may comprise a different material. The dielectric layers 117 and the dielectric layer 108 may be transparent or nearly transparent to light within the same range of wavelengths, in some embodiments. The dielectric layers 117 may be formed using a technique similar to those described above for the dielectric layer 108 or using a different technique. The conductive features 114 may include conductive lines and vias, and may be formed by a damascene process (e.g., single damascene, duel damascene), the like, or another process. As shown in FIG. 5, conductive pads 116 may be formed in the topmost layer of the dielectric layers 117. A planarization process (e.g., a CMP process or the like) may be performed after forming the conductive pads 116 such that surfaces of the conductive pads 116 and the topmost dielectric layer 117 are substantially coplanar (e.g., level). The redistribution structure 120 may include more or fewer dielectric layers 117, conductive features 114, or conductive pads 116 than shown in FIG. 6, and may have a different arrangement or configuration. The redistribution structure 120 may be formed having a thickness between about 4 μm and about 6 μm, in some embodiments. Other thicknesses are possible.

In FIG. 6, portions of the redistribution structure 120 are removed and replaced by a dielectric layer 115, in accordance with some embodiments. The portions of the redistribution structure 120 may be removed, for example, using acceptable photolithography and etching techniques, such as by forming and patterning a photoresist and then performing an etching process to remove the dielectric layers 117 using the patterned photoresist as an etching mask. The etching process may include, for example, a dry etching process and/or a wet etching process. Removing the portions of the redistribution structure 120 may expose the dielectric layer 108, in some embodiments. In other embodiments, the dielectric layer 108 may remain covered by one or more dielectric layers 117 after removing the portions of the redistribution structure 120.

After removing the portions of the redistribution structure, the dielectric layer 115 may then be deposited to replace the removed portions of the redistribution structure 120. The dielectric layer 115 may comprise one or more materials similar to those described above for the dielectric layer 108, such as a silicon oxide or a silicon nitride, or may comprise a different material. The dielectric layer 115 may be formed using a technique similar to those described above for the dielectric layer 108 or using a different technique. In some embodiments, a planarization process (e.g., a CMP or grinding process) is used to remove excess material of the dielectric layer 115. The planarization process may also expose the conductive pads 116. After performing the planarization process, the dielectric layer 115, the topmost dielectric layer 117, and/or the conductive pads 116 may have substantially level surfaces. In some cases, replacing a portion of the redistribution structure 120 with the dielectric layer 115 can improve the optical confinement within the waveguides 104 beneath the dielectric layer 115. In other embodiments, the redistribution structure 120 is not etched and the dielectric layer 115 is not formed. In other embodiments, etching the redistribution structure 120 separates the redistribution structure 120 into multiple separated regions.

In FIG. 7, one or more electronic dies 122 are bonded to the redistribution structure 120, in accordance with some embodiments. The electronic dies 122 may be, for example, semiconductor devices, dies, or chips that communicate with the photonic components 106 using electrical signals. One electronic die 122 is shown in FIG. 7, but an optical engine 100 may include two or more electronic dies 122 in other embodiments. In some cases, multiple electronic dies 122 may be incorporated into a single optical engine 100 in order to reduce processing cost. The electronic die 122 may include die connectors 124, which may be, for example, conductive pads, conductive pillars, or the like.

The electronic die 122 may include integrated circuits for interfacing with the photonic components 106, such as circuits for controlling the operation of the photonic components 106. For example, the electronic die 122 may include controllers, drivers, transimpedance amplifiers, the like, or combinations thereof. The electronic die 122 may also include a CPU. In some embodiments, the electronic die 122 includes circuits for processing electrical signals received from photonic components 106, such as for processing electrical signals received from a photonic component 106 comprising a photodetector. The electronic die 122 may control high-frequency signaling of the photonic components 106 according to electrical signals (digital or analog) received from another device or die, in some embodiments. In some embodiments, the electronic die 122 may be an electronic integrated circuit (EIC) or the like that provides Serializer/Deserializer (SerDes) functionality. In this manner, the electronic die 122 may act as part of an I/O interface between optical signals and electrical signals within an optical engine 100, and the optical engine 100 described herein could be considered a system-on-chip (SoC) device or a system-on-integrated-circuit (SoIC) device.

In some embodiments, the electronic die 122 is bonded to the redistribution structure 120 by dielectric-to-dielectric bonding and/or metal-to-metal bonding (e.g., direct bonding, fusion bonding, oxide-to-oxide bonding, hybrid bonding, or the like). In such embodiments, covalent bonds may be formed between bonding layers, such as the topmost dielectric layer 117 and surface dielectric layers (not separately indicated) of the electronic die 122. The bonding layers may be oxide layers or layers of other dielectric materials. During the bonding, metal-to-metal bonding may also occur between the die connectors 124 of the electronic die 122 and the conductive pads 116 of the redistribution structure 120. In other embodiments, the electronic die 122 may be bonded to the redistribution structure 120 using solder bonding, solder bumps, or the like.

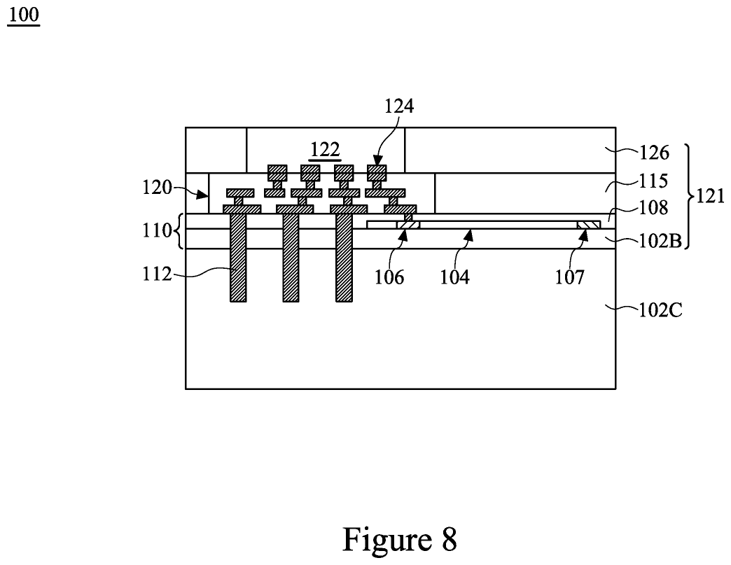

In FIG. 8, a dielectric material 126 is formed over the electronic die 122 and the redistribution structure 120, in accordance with some embodiments. The dielectric material 126 may be formed of silicon oxide, a flowable oxide, a glass, silicon nitride, a polymer, the like, or a combination thereof. The dielectric material 126 may be formed by CVD, PVD, ALD, a spin-on process, the like, or a combination thereof. In some embodiments, the dielectric material 126 may be formed by HDP-CVD, FCVD, the like, or a combination thereof. The dielectric material 126 may be a gap-filling material in some embodiments, which may include one or more of the example materials above. Other dielectric materials formed by any acceptable process may be used. The dielectric material 126 may be planarized using a planarization process such as a CMP process, a grinding process, or the like. In some embodiments, the planarization process may expose the electronic die 122 such that a surface of the electronic die 122 and a surface of the dielectric material 126 are substantially coplanar. The oxide layer 102B, the dielectric layer 108, the dielectric layer 115 and the dielectric material 126 may be collectively referred to herein as the dielectric layers 121.

In FIG. 9, an optional support 125 is attached to the structure, in accordance with some embodiments. The support 125 is attached to the structure in order to provide structural or mechanical stability. The use of a support 125 can reduce warping or bending, which can improve the performance of the optical structures such as the waveguides 104 or photonic components 106. The support 125 may comprise one or more materials such as silicon (e.g., a silicon wafer, bulk silicon, or the like), silicon oxide, silicon oxynitride, silicon carbonitride, a metal, an organic core material, the like, or another type of material. The support 125 may be attached to the structure (e.g., to the dielectric material 126 and/or the electronic dies 122) using an adhesive layer 127 or the like. In other embodiments, the support 125 may be attached using direct bonding (e.g., dielectric-to-dielectric bonding, fusion bonding, or the like) or another suitable technique. The support 125 may also have lateral dimensions (e.g., length, width, and/or area) that are greater than, about the same as, or smaller than those of the underlying structure. In other embodiments, the support 125 is attached at a later process step during the manufacturing of the optical engine 100 than shown. In some embodiments, the support 125 may be subsequently thinned using a CMP process, a grinding process, or the like. Further in FIG. 9, the back side of the substrate 102C may be thinned to expose the vias 112, in accordance with some embodiments. The substrate 102C may be thinned using a CMP process, a grinding process, an etching process, the like, or a combination thereof.

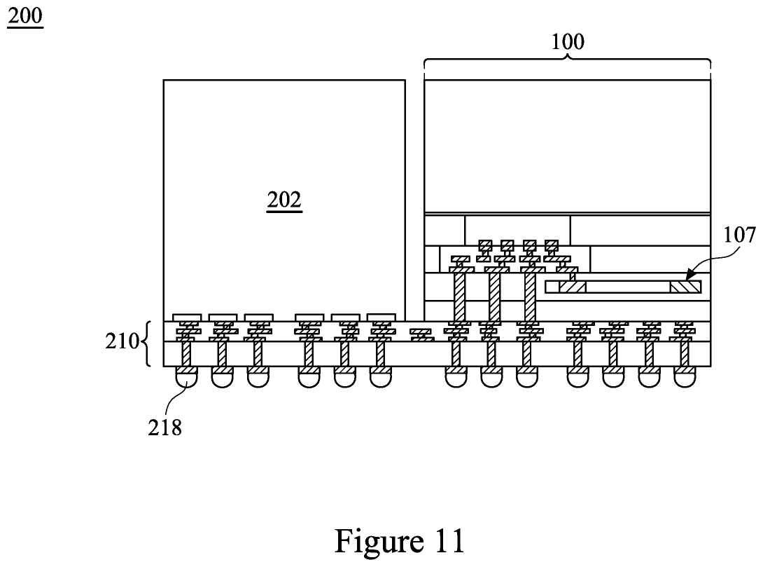

In FIG. 10, the optical engine 100 is optionally attached to an interconnect substrate 210 to form a photonic package 200, in accordance with some embodiments. The interconnect substrate 210 may comprise an interconnect structure 212 on a substrate 214, in some embodiments. The interconnect substrate 210 may also have through vias 216 extending through the substrate 214 that are electrically connected to the interconnect structure 212. The interconnect substrate 210 shown in FIG. 10 is an example, and other interconnect substrates or configurations thereof are possible. In some embodiments, the interconnect substrate 210 may be considered an interposer or the like. The interconnect substrate 210 may include passive or active devices, in some embodiments. In other embodiments, more than one optical engine 100 may be attached to an interconnect substrate 210. In other embodiments, one or more semiconductor devices may also be attached to an interconnect substrate 210, an example of which is described below for FIG. 11.

The substrate 214 of the interconnect substrate 210 may comprise, for example, a glass substrate, a ceramic substrate, a dielectric substrate, an organic substrate (e.g., an organic core), a semiconductor substrate (e.g., a semiconductor wafer), the like, or a combination thereof. The through vias 216 extend through the substrate 214 and may be formed using materials or techniques similar to those of the vias 112 or using different materials or techniques.

The interconnect structure 212 of the interconnect substrate 210 includes dielectric layers and conductive features formed in the dielectric layers, in some embodiments. The interconnect structure 212 provides interconnections and electrical routing, and may be electrically connected to the through vias 216 and/or the vias 112. The dielectric layers may be, for example, insulating or passivating layers, and may include a material similar to those described above for the dielectric layer 108 or the dielectric layers 117. For example, the dielectric layers of the interconnect structure 212 may include materials such as a silicon oxide, silicon nitride, or the like. The conductive features of the interconnect structure 212 may include conductive lines and vias, and may be formed using materials or techniques similar to those of the conductive features 114 or using different materials or techniques. For example, the conductive features of the interconnect structure 212 may be formed using a damascene process, e.g., dual damascene, single damascene, or the like.

In some embodiments, the optical engine 100 is bonded to the interconnect substrate 210 by dielectric-to-dielectric bonding and/or metal-to-metal bonding (e.g., direct bonding, fusion bonding, oxide-to-oxide bonding, hybrid bonding, or the like). For example, the back side of the optical engine 100 (e.g., the back side of the substrate 102C) may be bonded to the interconnect structure 212. In some embodiments, the vias 112 of the optical engine 100 are bonded to conductive features of the interconnect structure 212 to physically and electrically connect the optical engine 100 to the interconnect substrate 210. In some embodiments, a bonding layer may be formed on the back side of the substrate 102C prior to bonding with the interconnect substrate 210. In other embodiments, the optical engine 100 may be bonded to the interconnect substrate 210 using solder bonding, solder bumps, or the like.

In some embodiments, conductive connectors 218 are formed on the interconnect substrate 210, in accordance with some embodiments. The conductive connectors 218 are electrically connected to the interconnect substrate 210 by the through vias 216. In some embodiments, the conductive connectors 218 include conductive pads formed on the through vias 216 and the substrate 214. The conductive pads may be, for example, aluminum pads or aluminum-copper pads, although other metallic pads may be used. The conductive pads may include underbump metallizations (UBMs), in some embodiments.

The conductive connectors 218 may include solder balls, solder bumps, or the like formed on the conductive pads, in some embodiments. For example, the conductive connectors 218 may include ball grid array (BGA) connectors, solder balls, metal pillars, controlled collapse chip connection (C4) bumps, micro bumps, electroless nickel-electroless palladium-immersion gold technique (ENEPIG) formed bumps, or the like. The conductive connectors 218 may include a conductive material such as solder, copper, aluminum, gold, nickel, silver, palladium, tin, the like, or a combination thereof. In some embodiments, the conductive connectors 218 are formed by initially forming a layer of solder through such commonly used methods such as evaporation, electroplating, printing, solder transfer, ball placement, or the like. Once a layer of solder has been formed on the structure, a reflow may be performed in order to shape the material into the desired bump shapes. In another embodiment, the conductive connectors 218 include metal pillars (such as a copper pillar) formed by a sputtering, printing, electro plating, electroless plating, CVD, or the like. The metal pillars may be solder free and have substantially vertical sidewalls. In some embodiments, a metal cap layer (not shown) is formed on the top of the conductive connectors 218. The metal cap layer may include nickel, tin, tin-lead, gold, silver, palladium, indium, nickel-palladium-gold, nickel-gold, the like, or a combination thereof and may be formed by a plating process.

In some embodiments, a photonic package 200 may include one or more semiconductor dies connected to the interconnect substrate 210 in addition to the optical engine 100. For example, FIG. 11 illustrates a photonic package 200 including a single semiconductor die 202, in accordance with some embodiments. The one or more semiconductor dies may include, for example, a chip, die, system-on-chip (SoC) device, system-on-integrated-circuit (SoIC) device, package, the like, or a combination thereof. The semiconductor die(s) may include one or more processing devices, such as a central processing unit (CPU), a graphics processing unit (GPU), an application-specific integrated circuit (ASIC), a high performance computing (HPC) die, the like, or a combination thereof. The semiconductor die(s) may include one or more memory devices, which may be a volatile memory such as dynamic random-access memory (DRAM), static random-access memory (SRAM), high-bandwidth memory (HBM), another type of memory, or the like. The one or more semiconductor dies may be attached to the interconnect structure 212 of the interconnect substrate 210 using direct bonding, solder bumps, or the like. In this manner, the semiconductor die(s) are electrically connected to the interconnect substrate 210, and may be electrically coupled to one or more optical engines 100 by the interconnect substrate 210. The photonic package 200 shown in FIG. 11 is an example, and other photonic packages or configurations thereof are possible.

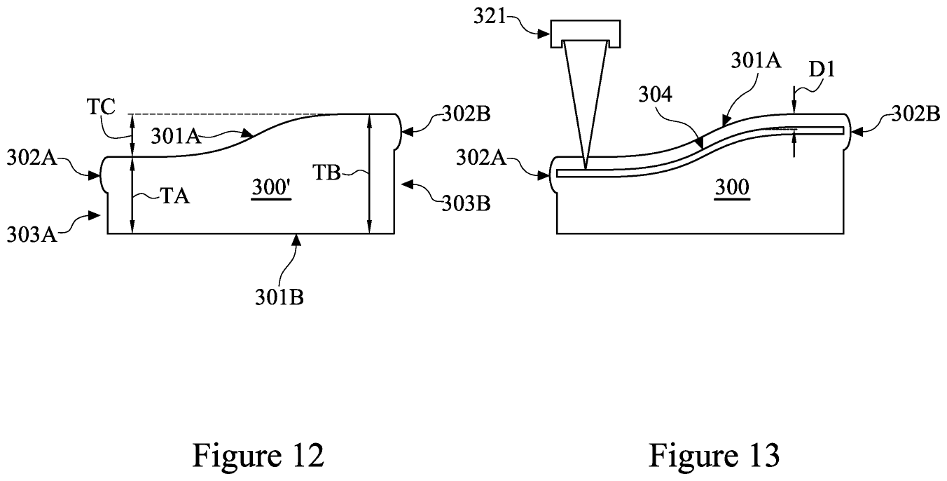

FIGS. 12 and 13 illustrate cross-sectional views of intermediate steps in the formation of a waveguide structure 300, in accordance with some embodiments. The waveguide structure 300 is a structure that provides optical coupling between waveguides (e.g., waveguides 104 of an optical engine 100) and an external optical fiber, in accordance with some embodiments. The waveguide structure 300 may be used, for example, to provide optical coupling within a photonic system, such as photonic system 500 described below for FIG. 19, or the like.

FIG. 12 illustrates a cross-sectional view of a shaped block 300′, in accordance with some embodiments. One or more waveguides 304 are subsequently formed in the shaped block 300′ using a laser-writing process or the like, described in greater detail below for FIG. 13. Accordingly, the material of the shaped block 300′ may comprise a material that is suitable for a laser-writing, such as a borosilicate glass, a soda-lime-silica glass, a fluoride glass (e.g., fluorozirconate glass or the like), another type of glass, a high-silica (e.g. silicon oxide-based) material, a polymer, or the like. The material of the shaped block 300′ may be transparent to appropriate laser wavelengths. The shaped block 300′ may be considered a “waveguide substrate,” in some cases. The shaped block 300′ may be formed using suitable techniques that form the shaped block 300′ as a single piece, such as glass molding techniques or the like. For example, the shaped block 300′ may be formed as a single piece of material having the lenses 302A-B and the desired contour of the curved surface 301A, described in greater detail below. In some cases, the various features of the shaped block 300′ may be formed or designed according to the specifications or configuration of a photonic system in which it is used. Forming a shaped block 300′ using a glass molding process or the like can allow for design flexibility, improve structural stability, reduce cost, and/or reduce the size of a photonic system.

With reference to FIG. 12, the shaped block 300′ has a first end 303A and a second end 303B opposite the first end 303A. In some embodiments, the shaped block 300′ at the first end 303A and at the second end 303B may have different thicknesses (e.g., different heights). For example, the shaped block 300′ shown in FIG. 12 has a first end 303A with a first thickness TA and a second end 303B with a second thickness TB, in which the first thickness TA is smaller than the second thickness TB. In some embodiments, the first thickness TA may be in the range of about 200 μm to about 2000 μm, and the second thickness TB may be in the range of about 200 μm to about 2000 μm. In some embodiments, the difference between the first thickness TA and the second thickness TB is a thickness difference TC that is in the range of about 0 μm and about 1000 μm. Other thicknesses or relative thicknesses are possible. The ends 303A-B of the shaped block 300′ may be formed having different thicknesses to facilitate the formation and alignment of subsequently-formed waveguides 304 (see FIG. 13). In particular, the thickness difference TC of a shaped block 300′ may be controlled or configured to align respective ends of the subsequently formed waveguides 304 (see FIG. 13) to optical features such as the edge couplers 107 of a photonic package 200, optical fibers, fiber arrays, the like, or other optical components, described in greater detail below.

The ends 303A-B of the shaped block 300′ may be flat, concave, convex, irregular, stepped, or curved. In some embodiments, each end 303A-B may include one or more lenses 302 (e.g., lenses 302A-B in FIG. 12). Each lens 302 may be formed as a portion of the respective end 303A-B surface that protrudes from surrounding surfaces (e.g., “non-lens surfaces”). In some cases, forming the lenses 302A-B as part of the shaped block 300′ instead of separately can allow for improved optical coupling. The lenses 302A-B are described in greater detail below. In some embodiments, a distance between opposite ends 303A-B of a shaped block 300′ is a length in the range of about 300 μm to about 3000 μm, though other lengths are possible.

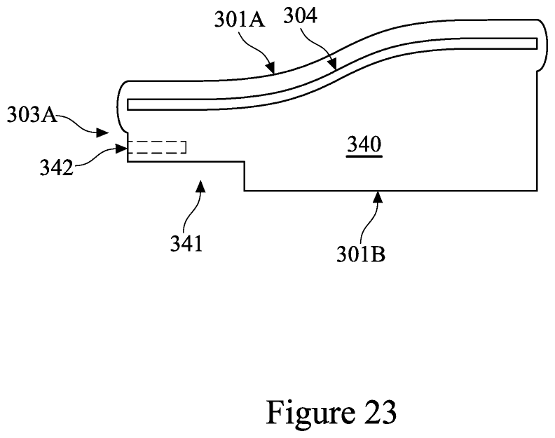

With regard to FIG. 12, the shaped block 300′ has a first surface 301A at a top side or front side of the shaped block 300′ and a second surface 301B at a bottom side or back side of the shaped block 300′. The surfaces 301A-B extend from the first end 303A to the second end 303B. In the embodiment of FIG. 12, the first surface 301A is a curved (e.g., nonplanar) surface and the second surface 301B is a flat (e.g., planar) surface. In some embodiments, the first surface 301A may have a “S-shaped” profile, a “sigmoid” profile, a “smoothed step” profile, a “spline-like” profile, another type of profile, or the like. For example, some regions of the first surface 301A at or near the ends 303A-B may be approximately horizontal (e.g., approximately parallel to the second surface 301A of FIG. 12), and some regions of the first surface 301A at or near the center of the first surface 301A may be angled, sloped, or curved. The shaped block 300′ of FIG. 12 is an example, and the surfaces 301A and/or 301B may have other shapes, curvatures, slopes, contours, or profiles in other embodiments. For example, one or both of the surfaces 301A-B may be flat, convex, concave, stepped, irregular, or angled. In some cases, the second surface 301B may have a step, notch, groove, or the like that facilitates placement or mounting in a holder, an example of which is described below for FIG. 23. In some cases, forming a shaped block 300′ having a curved first surface 301A as described herein may allow for improved formation of waveguides 304, described in greater detail below for FIG. 13.

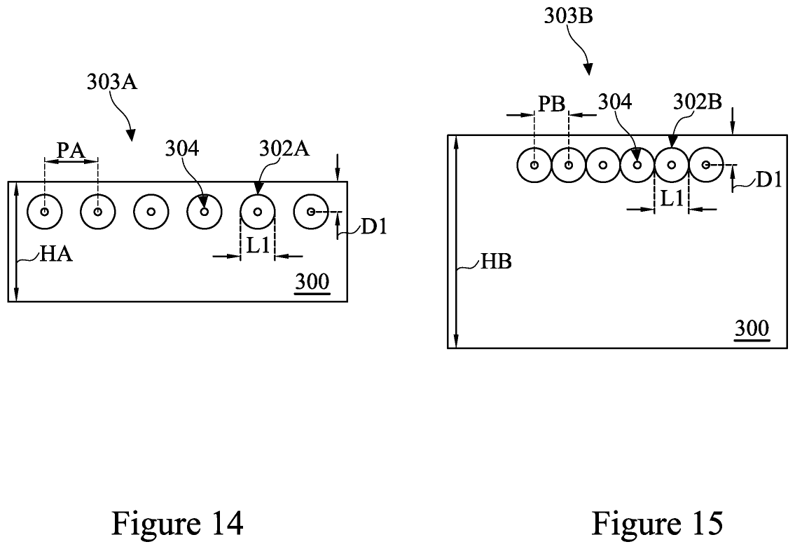

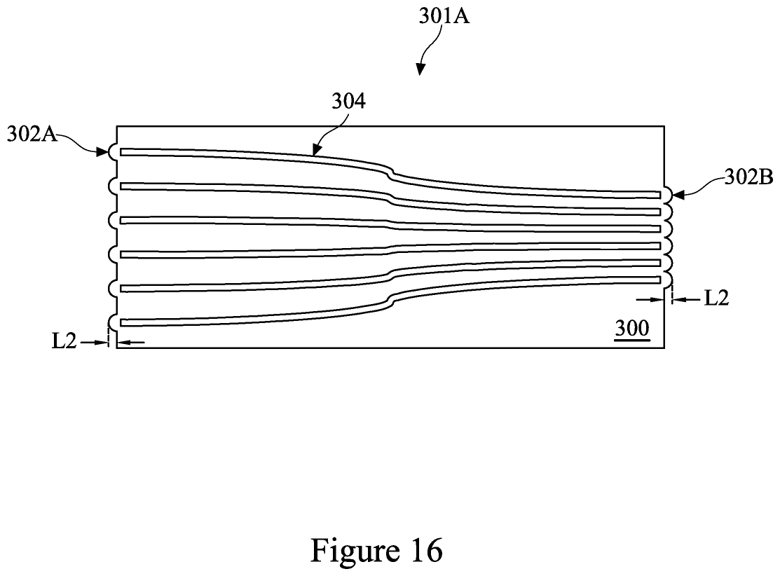

As mentioned previously, one or more lenses 302A are formed on the first end 303A and one or more lenses 302B are formed on the second end 303B. The one or more lenses 302A-B may be formed during formation of the shaped block 300′ itself. For example, the lenses 302A-B may protrude from surrounding (e.g., “non-lens”) surfaces of the ends 302A-B. In some embodiments, each lens 302 may correspond to a subsequently-formed waveguide 304 (see FIG. 13). For example, a waveguide 304 may have a corresponding lens 302A near an end of the waveguide 304 and a corresponding lens 302B near the opposite end of the waveguide 304. In other embodiments, a waveguide 304 may have only either a lens 302A or a lens 302B. The lenses 302A-B may be formed on the ends 303A-B near the first surface 301A. The lenses 302A-B can provide improved optical coupling of the waveguides 304 to other optical features (e.g., edge couplers 107 or other optical components) and can allow for larger misalignment tolerance. The lenses 302A-B may be convex, circular, spherical, elliptical, ellipsoidal, annular, rectangular, cylindrical, or have another suitable shape. For example, in some embodiments, the lenses 302A-B may have a width L1 (see FIGS. 14-15) in the range of about 30 μm to about 500 μm and may protrude a distance L2 (see FIG. 16) in the range of about 10 μm to about 500 μm, though other dimensions are possible. The widths L1 and/or distances L2 of the lenses 302A may be different than the lenses 302B, in some embodiments.

FIG. 13 illustrates a cross-sectional view of the formation of waveguides 304 in the shaped block 300′ to form a waveguide structure 300, in accordance with some embodiments. FIGS. 14, 15, and 16 illustrate various views of waveguide structure 300 similar to that shown in FIG. 13. FIG. 14 illustrates a view of the waveguide structure 300 towards the first end 303A, FIG. 15 illustrates a view of the waveguide structure 300 towards the second end 303B, and FIG. 16 illustrates a plan view of the waveguide structure 300 towards the first surface 301A.

The waveguides 304 may be formed, for example, using a laser writing process or the like, represented in FIG. 13 by laser writing device 321. A laser writing process focuses a laser on a localized region within the shaped block 300′, changing the material properties of that localized region. For example, the laser may increase the refractive index of the localized region relative to adjacent (e.g., not laser-written) regions of the shaped block 300′. By performing the laser writing process along a path within the shaped block 300′, continuous laser-written portions of the shaped block 300′ may be formed that act as a waveguide (e.g., a waveguide 304). The laser writing process may be performed multiple times to form multiple waveguides 304 within the shaped block 300′. The laser writing process used to form the waveguides 304 may be a Femtosecond Direct Laser Writing process or the like, in some embodiments. In some embodiments, the size, shape, location, optical properties, or other properties of a waveguide 304 may depend on the material(s) of the shaped block 300′ or may be controlled by controlling parameters such as laser wavelength, laser pulse energy, focal spot size, laser intensity profile or phase profile, laser pulse width (e.g., duration), laser pulse repetition rate or duty cycle, laser writing path speed, laser writing direction, laser polarization, or other parameters.

In some embodiments, the waveguides 304 are formed in the shaped block 300′ near the first surface 301A. In other words, the laser of the laser-writing process is directed through the first surface 301A to form waveguides 304 underneath the first surface 301. In some embodiments, the waveguides 304 are formed an approximately constant distance D1 beneath the first surface 301A. In this manner, the path of each waveguide 304 may approximately follow the profile or contour of the overlying first surface 301A. The depth D1 below the first surface 301A may be a distance in the range of about 5 μm to about 700 μm, though other distances are possible. The distance D1 may correspond to the vertical distance between the first surface 301A and an approximately central point of the underlying waveguide 304. In some embodiments, the waveguides 304 are closer to the first surface 301A than the second surface 301B. In other embodiments, portions of the waveguides 304 near the first end 303A may be closer to the second surface 301B than the first surface 301A, but portions of the waveguides 304 near the second end 303B may be closer to the first surface 301A than the second surface 301B. In this manner, ends of the waveguides 304 near the first end 303A may be approximately at a first height (HA-D1) above the second surface 301B and ends of the waveguides 304 near the second end 303B may be approximately at a second height (HB-D1) above the second surface 301B.

In some cases, regions that are deeper beneath a surface can be more prone to undesirable optical phenomena during a laser writing process, such as spherical aberration or the like. This can cause, for example, poorer localization of deeper laser-written regions, or can cause laser-written regions to have different shapes at different depths. Accordingly, in some cases, waveguides formed relatively farther from a surface can have poorer optical properties or performance (e.g., worse propagation loss) than waveguides formed relatively closer to a surface. Additionally, forming a single waveguide having portions at different depths beneath a surface can result in those waveguide portions having inconsistent optical or physical properties, such as different propagation losses or different cross-sectional shapes. Accordingly, the curved first surface 301A of the shaped block 300′ allows the waveguides 304 to be formed at an approximately constant shallow depth (e.g., depth D1) below a surface rather than at different depths below a surface, even if the ends of the waveguides 304 are at different heights. In this manner, improved laser-written waveguides that extend from a first height to a second height may be formed, which can allow for more efficient optical coupling, improved device performance, and more flexible waveguide design.

In some embodiments, the waveguides 304 are formed such that each lens 302A-B is adjacent to and associated with a respective end of a waveguide 304. In some embodiments, some or all of the ends of the waveguides 304 are not adjacent a respective lens 302A-B. In other words, in some embodiments, associated lenses 302A-B may not be formed for some or all of the ends of the waveguides 304. In some embodiments, the ends of the waveguides 304 may be formed such that each end protrudes into its associated lens 302A-B, or the ends of the waveguides 304 may be formed such that each end is separated from its associated lens 302A-B. In other words, an end of a waveguide 304 may be approximately aligned with (e.g., flush with) the non-lens surfaces of the adjacent end 303A-B or may not be aligned with the non-lens surfaces of the adjacent end 303A-B.

In addition to providing coupling between optical features (e.g., edge couplers 107 or other optical components) of different heights, the waveguide structure 300 described herein can provide coupling between optical features of different pitches or arrangements. For example, referring to FIGS. 14-16, the waveguides 304 of the waveguide structure 300 may be formed having a first pitch PA at the first end 303A and a second pitch PB at the second end 303B. In some embodiments, the first pitch PA may be in the range of about 100 μm to about 500 μm and the second pitch PB may be in the range of about 30 μm to about 500 μm, though other pitches are possible. In this manner, the waveguide structure 300 may be considered a “fan-in” structure or a “fan-out” structure for optical coupling, and allow for optical coupling between optical features of different sizes or different arrangements. As shown in the plan view of FIG. 16, the waveguides 304 may be formed to extend or spread laterally (e.g., horizontally or transversely) between the ends 303A-B. The waveguides 304 may be substantially linear or may be curved when viewed in a plan view, and the plan view of FIG. 16 shows both linear and curved waveguides 304 as a representative example. In some embodiments, the width of the waveguides 304 may be different at one end than at the other end to provide improved coupling to the particular optical features at the ends.

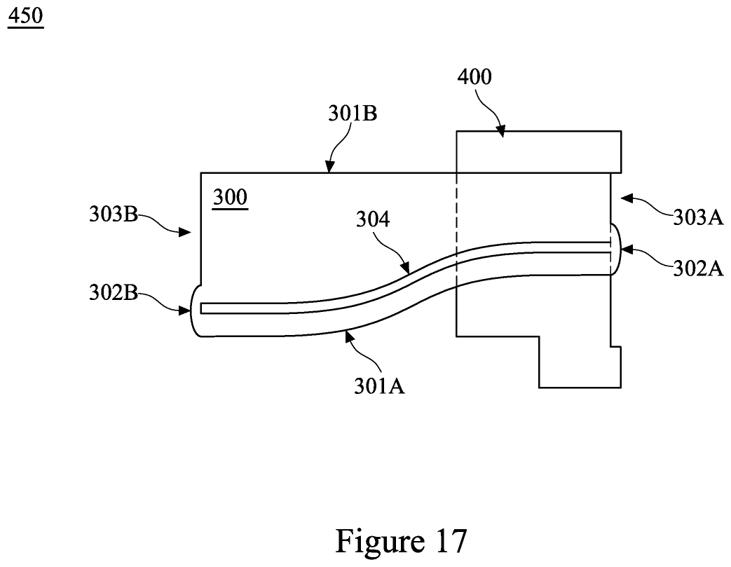

FIG. 17 illustrates the attachment of a waveguide structure 300 in a holder 400, in accordance with some embodiments. The holder 400 secures the waveguide structure 300 and facilitates optical coupling of the waveguides 304 of the waveguide structure 300 to an optical component (not shown). For example, the holder 400 may be connected or mounted to an optical component such as an optical fiber, an MT ferrule, a fiber array (e.g., a fiber array unit), an MPO connector, an MTP connector, a fiber cable, or the like such that the optical component is optically coupled to waveguides 304 of the waveguide structure 300. In some embodiments, a portion of the waveguide structure 300 near the first end 303A may be inserted or placed into an opening within the holder 400. The opening within the holder 400 may have a shape corresponding to the shape of the inserted portion of the waveguide structure 300, in some embodiments. In this manner, the waveguide structure 300 may be more securely held by the holder 400. In some cases, an adhesive may be used to further secure the waveguide structure 300 to the holder 400. The holder 400 may also be shaped or configured to allow an optical component to be connected or mounted to the holder 400 such that the optical component is optically aligned with the waveguides 304 at the first end 303A. In some cases, the lenses 302A may improve optical coupling and misalignment tolerance between the waveguides 304 and the optical component connected to the holder 400. The holder 400 shown in FIG. 17 is a representative example, and other holders 400 having other shapes, sizes, or configurations are possible. The waveguide structure 300 and the holder 400 may collectively be referred to as the coupling structure 450 herein.

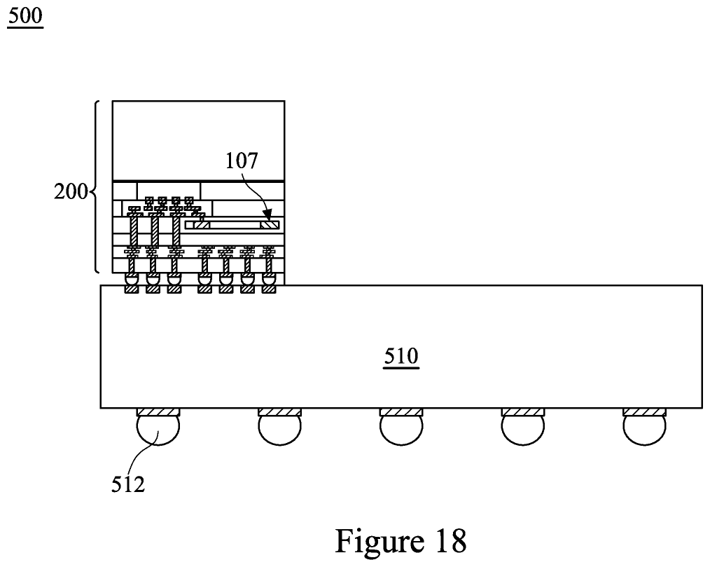

FIGS. 18 and 19 illustrate intermediate steps in the formation of a photonic system 500 (see FIG. 19), in accordance with some embodiments. In FIG. 18, a photonic package 200 is connected to a package substrate 510, in accordance with some embodiments. The photonic package 200 may be similar to the photonic packages 200 described previously for FIGS. 10-11. Multiple photonic packages 200 may be attached to the package substrate 510 in other embodiments. In some embodiments, the package substrate 510 comprises conductive pads, conductive routing, and/or other conductive features such as through substrate vias (TSVs). In some embodiments, the package substrate 510 may comprise an interposer, a semiconductor substrate, a redistribution structure, a core substrate, a printed circuit board (PCB), or a different type of structure than these examples. In some embodiments, the package substrate 510 comprises active and/or passive devices. In other embodiments, the package substrate 510 is free of active and/or passive devices. In some embodiments, conductive connectors 512 are formed on the package substrate 510, as shown in FIG. 18. The conductive connectors 512 may be similar to the conductive connectors 218 described previously, and may be formed using similar materials or techniques. For example, the conductive connectors 512 may comprise solder bumps or the like.

In some embodiments, the conductive connectors 218 of the photonic package 200 are placed on corresponding conductive pads of the package substrate 510 and then performing a reflow process to bond the photonic package 200 to the package substrate 510. In this manner, the photonic package 200 may be electrically connected to the package substrate 510. In other embodiments, the photonic package 200 may be bonded to the package substrate 510 using dielectric-to-dielectric bonding and/or metal-to-metal bonding (e.g., direct bonding, fusion bonding, oxide-to-oxide bonding, hybrid bonding, or the like).

In FIG. 19, a coupling structure 450 is attached to the package substrate 510 to form a photonic system 500, in accordance with some embodiments. Multiple coupling structures 450 may be attached in other embodiments. In some embodiments, the coupling structure 450 may be placed on the package substrate 510 such that waveguides 304 of the waveguide structure 300 are optically aligned with corresponding edge couplers 107 of the photonic package 200. In some cases, the lenses 302B may improve optical coupling and misalignment tolerance between the waveguides 304 and the photonic package 200. In some embodiments, the coupling structure 450 may be actively aligned to the photonic package 200, in which an optical signal strength is monitored during alignment. In some embodiments, an optical adhesive 514 or the like may be deposited between the coupling structure 450 and the photonic package 200 and/or between the coupling structure 450 and the package substrate 510. In this manner, a photonic system 500 may be formed in which the coupling structure 450 facilitates the transmission of optical signals and/or optical power between a photonic package 200 and an optical component.

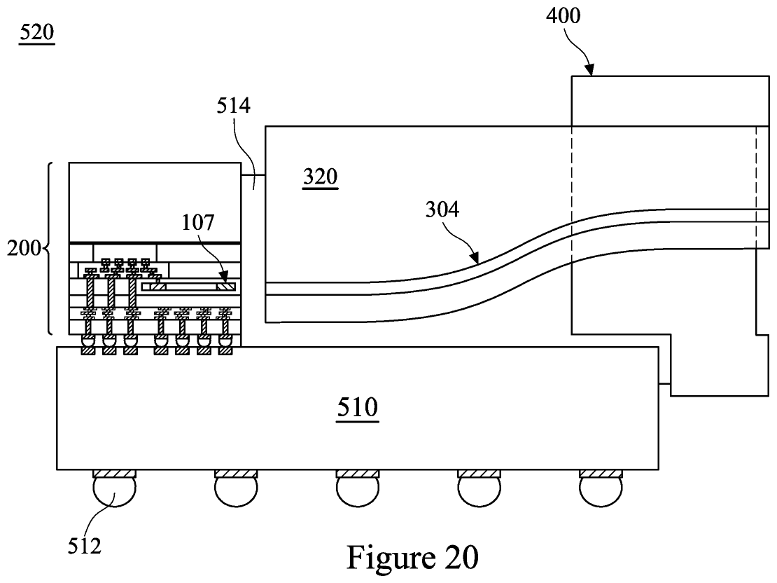

FIG. 20 illustrates a photonic system 520, in accordance with some embodiments. The photonic system 520 is similar to the photonic system 500, except that the waveguide structure 320 of the photonic system 520 does not have lenses 302A-B. In other embodiments, lenses may be formed on only one end (e.g., 303A or 303B) of a waveguide structure.

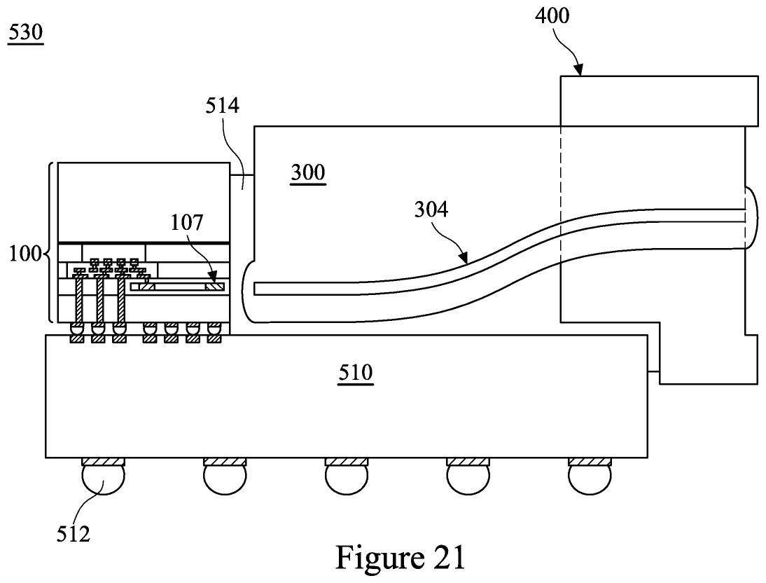

FIG. 21 illustrates a photonic system 530, in accordance with some embodiments. The photonic system 530 is similar to the photonic system 500, except that the optical engine 100 is not connected to an interconnect substrate 210, but is connected to the package substrate 510. In some embodiments, conductive connectors may be formed on the optical engine 100 and then bonded to conductive pads of the package substrate 510. The conductive connectors may be similar to the conductive connectors 218 or the conductive connectors 512 described previously. In other embodiments, the optical engine 100 may be bonded to the package substrate 510 using dielectric-to-dielectric bonding and/or metal-to-metal bonding (e.g., direct bonding, fusion bonding, oxide-to-oxide bonding, hybrid bonding, or the like).

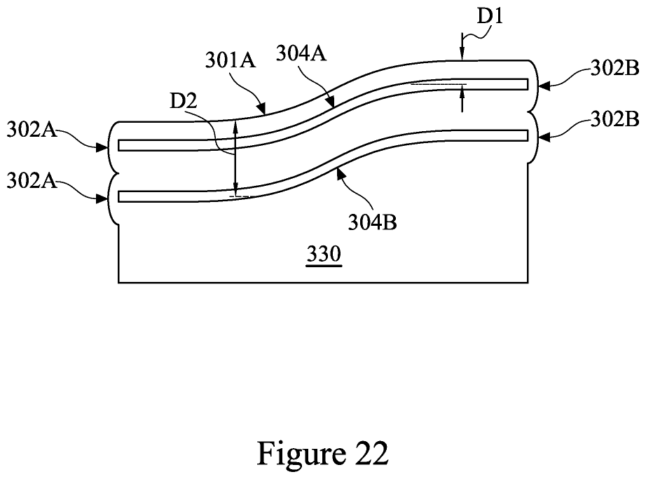

FIG. 22 illustrates a waveguide structure 330, in accordance with some embodiments. The waveguide structure 330 is similar to the waveguide structure 300, except that the waveguide structure 330 includes waveguides formed at different depths from the first surface 301A. For example, the waveguide structure 330 includes a first set of waveguides 304A at a depth D1 and a second set of waveguides 304B at a depth D2, in which the depth D2 is greater than the depth D1. More sets of waveguides are possible. In some embodiments, the waveguide structure 330 may be formed by forming the second set of waveguides 304B using a laser writing process and then forming the first set of waveguides 304A using a laser writing process. The waveguide structure 330 may include optional lenses 302A-B.

FIG. 23 illustrates a waveguide structure 340, in accordance with some embodiments. The waveguide structure 340 is similar to the waveguide structure 300, except that the waveguide structure 340 includes a recess 341 in the second surface 301B. The recess 341 may be, for example, a groove, notch, slot, or the like that interfaces with the holder 400 to facilitate insertion, placement, or alignment of the waveguide structure 340 in the holder 400. For example, a protruding portion of the holder 400 may fit within the recess 341, or the sidewall of the recess 341 may act as a stop against a sidewall of the holder 400. Other examples or applications are possible. The waveguide structure 340 also illustrates a pinhole 342 formed in the first end 303A, in accordance with some embodiments. One or more pinholes 342 may be formed in the waveguide structure 340 to facilitate alignment with an optical component. For example, an optical component may comprise a pin that is inserted into the pinhole 342 when the optical component is connected to the holder (e.g., holder 400). The various features of the various embodiments of optical engines, photonic packages, photonic systems, waveguide structures, and holders described herein may be combined or reconfigured, and all such variations are considered within the scope of the present disclosure.

The embodiments of the present disclosure have some advantageous features. By forming waveguide structures that include laser written waveguides therein, optical components (e.g., optical fibers) may be integrated with optical engines. The waveguide structures allow transmission of optical power and/or optical signals between optical features of the optical engines (e.g., edge couplers) and optical components, in which the optical features and the optical components have different sizes, pitches or heights. In this manner, the waveguide structure described herein may act as a fiber array unit (FAU). Additionally, by forming a waveguide structure from a block having a curved surface, waveguides may be laser written at a consistent depth, which can improve the quality and uniformity of the waveguides. The curved surface allows waveguides to be laser written at a consistent depth even if different portions of the waveguides have different heights. The block may be formed, for example, of molded glass or the like, which allows the waveguide structure to be customized for a variety of applications or configurations.

In an embodiment of the present disclosure, a package includes an optical engine attached to a package substrate, wherein the optical engine includes a first waveguide; and a waveguide structure attached to the package substrate adjacent the optical engine, wherein the waveguide structure includes a second waveguide within a transparent block, wherein a bottom surface of the transparent block is nonplanar, wherein the second waveguide is a fixed distance from the bottom surface along its length, wherein the second waveguide is optically coupled to the first waveguide. In an embodiment, the fixed distance is in the range of 5 μm to 700 μm. In an embodiment, a top surface of the transparent block is planar. In an embodiment, the transparent block and the second waveguide are the same material. In an embodiment, the transparent block includes lenses protruding from sidewalls of the transparent block, wherein the lenses are adjacent respective ends of the second waveguide. In an embodiment, the second waveguide is a laser-written waveguide. In an embodiment, a first portion of the bottom surface near a first end of the transparent block is closer to the package substrate than a second portion of the bottom surface near a second end of the transparent block that is opposite the first end. In an embodiment, the second waveguide is optically coupled to the first waveguide by and edge coupler within the optical engine. In an embodiment, the package further includes a holder, wherein the transparent block is secured by the holder, wherein the holder is configured to attach to an optical fiber, wherein the second waveguide is optically coupled to the optical fiber when the optical fiber is attached to the holder.

In an embodiment of the present disclosure, a structure includes a glass block having a first end and a second end opposite the first end, wherein a first thickness of the glass block at the first end is greater than a second thickness of the glass block at the second end, wherein the glass block has a curved surface extending from the first end to the second end; waveguides within the glass block, wherein the waveguides extend between the first end and the second end, wherein each waveguide has a curvature corresponding to a curvature of the curved surface; and a holder surrounding the second end of the glass block, wherein the holder is configured to connect to an optical fiber. In an embodiment, the first thickness is between 0 μm and 1000 μm greater than the second thickness. In an embodiment, the glass block has a top surface opposite the curved surface, wherein the plurality of waveguides are closer to the curved surface than to the top surface. In an embodiment, the top surface is flat. In an embodiment, the waveguides have a first pitch near the first end and a second pitch near the second end, wherein the first pitch is different than the second pitch.

In an embodiment of the present disclosure, a method includes forming a transparent block using a molding process, wherein the transparent block has a flat bottom surface and a curved top surface opposite the flat bottom surface; and performing a laser writing process through the curved top surface to form a waveguide below the curved top surface, wherein each portion of the waveguide is the same depth below a respectively overlying portion of the curved top surface. In an embodiment, the curved top surface has an S-shaped profile. In an embodiment, the transparent block includes a lens protruding from a sidewall of the transparent block. In an embodiment, the method includes attaching the transparent block to a holder to form a coupling structure and attaching an optical fiber component to the holder, wherein the optical fiber component is optically coupled to the waveguide. In an embodiment, the optical fiber component is an MT ferrule. In an embodiment, the method includes attaching the coupling structure to a photonic package, wherein an edge coupler of the photonic package is optically coupled to the waveguide.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A package comprising:
an optical engine attached to a package substrate, wherein the optical engine comprises a first waveguide; and
a waveguide structure attached to the package substrate adjacent the optical engine, wherein the waveguide structure comprises a second waveguide within a transparent block, wherein a bottom surface of the transparent block is nonplanar, wherein the second waveguide is a fixed distance from the bottom surface along its length, wherein the second waveguide is optically coupled to the first waveguide.

2. The package of claim 1, wherein the fixed distance is in the range of 5 μm to 700 μm.

3. The package of claim 1, wherein a top surface of the transparent block is planar.

4. The package of claim 1, wherein the transparent block and the second waveguide are the same material.

5. The package of claim 1, wherein the transparent block comprises lenses protruding from sidewalls of the transparent block, wherein the lenses are adjacent respective ends of the second waveguide.

6. The package of claim 1, wherein the second waveguide is a laser-written waveguide.

7. The package of claim 1, wherein a first portion of the bottom surface near a first end of the transparent block is closer to the package substrate than a second portion of the bottom surface near a second end of the transparent block that is opposite the first end.

8. The package of claim 1, wherein the second waveguide is optically coupled to the first waveguide by and edge coupler within the optical engine.

9. The package of claim 1 further comprising a holder, wherein the transparent block is secured by the holder, wherein the holder is configured to attach to an optical fiber, wherein the second waveguide is optically coupled to the optical fiber when the optical fiber is attached to the holder.

10. A structure comprising:
a glass block having a first end and a second end opposite the first end, wherein a first thickness of the glass block at the first end is greater than a second thickness of the glass block at the second end, wherein the glass block comprises a curved surface extending from the first end to the second end;
a plurality of waveguides within the glass block, wherein the plurality of waveguides extend between the first end and the second end, wherein each waveguide of the plurality of waveguides has a curvature corresponding to a curvature of the curved surface; and
a holder surrounding the second end of the glass block, wherein the holder is configured to connect to an optical fiber.

11. The structure of claim 10, wherein the first thickness is between 0 μm and 1000 μm greater than the second thickness.

12. The structure of claim 10, wherein the glass block comprises a top surface opposite the curved surface, wherein the plurality of waveguides are closer to the curved surface than to the top surface.

13. The structure of claim 12, wherein the top surface is flat.

14. The structure of claim 10, wherein the plurality of waveguides have a first pitch near the first end and a second pitch near the second end, wherein the first pitch is different than the second pitch.

15. A method comprising:
forming a transparent block using a molding process, wherein the transparent block comprises a flat bottom surface and a curved top surface opposite the flat bottom surface; and
performing a laser writing process through the curved top surface to form a waveguide below the curved top surface, wherein each portion of the waveguide is the same depth below a respectively overlying portion of the curved top surface.

16. The method of claim 15, wherein the curved top surface has an S-shaped profile.

17. The method of claim 15, where the transparent block comprises a lens protruding from a sidewall of the transparent block.

18. The method of claim 15 further comprising:
attaching the transparent block to a holder to form a coupling structure; and
attaching an optical fiber component to the holder, wherein the optical fiber component is optically coupled to the waveguide.

19. The method of claim 18, wherein the optical fiber component is an MT ferrule.

20. The method of claim 18 further comprising attaching the coupling structure to a photonic package, wherein an edge coupler of the photonic package is optically coupled to the waveguide.
